(19) United States
(12) Patent Application Publication
(10) Pub. No.: US 2017/0083849 A1
(43) Pub. Date: Mar. 23, 2017

(54) GENERATING A DATABASE OF SKILLS

(71) Applicant: International Business Machines Corporation, Armonk, NY (US)

(72) Inventors: Paul R. Bastide, Boxford, MA (US); Matthew E. Broomhall, Goffstown, NH (US); Sean Callanan, Dublin (IE); Sandra L. Kogan, Newton, MA (US)

(73) Assignee: International Business Machines Corporation, Armonk, NY (US)

(21) Appl. No.: 14/859,698

(22) Filed: Sep. 21, 2015

(51) Int. Cl. G06Q 10/06; G06F 17/30

(52) U.S. Cl. CPC G06Q 10/063112; G06F 17/30312

(57) ABSTRACT

Generating a database of skills possessed by a user includes with an electronic interaction tool, detecting an interaction between a requested user and an initiating user with regard to a collaboration activity, in response to a determination that the requested user uses at least one skill from a list of skills associated with the collaboration activity, generating a prompt for the initiating user that identifies the at least one skill of the requested user, and recording in a database a record associated with the requested user based on the collaboration activity, the record documenting the collaboration activity and the requested user's use of the at least one skill in connection with the collaboration activity.

### BACKGROUND

User may interact with each other via an electronic mail (email), a short message service (SMS), or a phone call. Each of the users that are interacting may have a specific set of skills. A user who initiates the interaction user will want to know what skills the other users have so as to be able to best utilize their skills with regard to work, whether professional or otherwise during the interaction. Also, the users will want to continue to hone and expand their skills in an ever changing business and economic environment.

### BRIEF SUMMARY

A method for generating a database of skills possessed by a user includes, with an electronic interaction tool, detecting an interaction between a requested user and an initiating user with regard to a collaboration activity, in response to a determination that the requested user uses at least one skill from a list of skills associated with the collaboration activity, generating a prompt for the initiating user that identifies the at least one skill of the requested user, and recording in a database a record associated with the requested user based on the collaboration activity, the record documents the collaboration activity and the requested user's use of the at least one skill in connection with the collaboration activity.

A system for generating a database of skills possessed by a user includes a processor, memory, communicatively connected to the processor, a skill database generator, the skill database generator includes a create engine to create a skill taxonomy, the skill taxonomy describing a classification of skills that are used in connection with a collaboration activity, a detect engine to detect, with an electronic interaction tool, an interaction between a requested user and an initiating user with regard to the collaboration activity, a generate engine to generate, in response to a determination that the requested use will use at least one skill from a list of skills associated with the collaboration activity, generate a prompt for the initiating user to identify at least one skill of the requested user, a record engine to record, in a database, a record associated with the requested user based on the collaboration activity, the record documenting the collaboration activity and the requested user's use of the at least one skill in connection with the collaboration activity, and a provide engine to selectively provide, based on a number of records associated with the requested user, a user profile, the user profile describing a number of skills the requested user has used, when each of the number of skills was used, and with which collaboration activity the number of skills were used.

A machine-readable storage medium encoded with instructions for generating a database of skills possessed by a user, the instructions executable by a processor of a system to cause the system to create a skills taxonomy, the skills taxonomy describing a classification of skills that are used in connection with a number of collaboration activities, detect, with an electronic interaction tool, an interaction between an requested user and an initiating user with regard to a collaboration activity, generate in response to a determination that the requested user uses at least one skill associated with the collaboration activity, a prompt for the initiating user to identify at least one skill of the requested user, and record, in a database, a record associated with the requested user based on the collaboration activity, the record documenting the collaboration activity and the requested user's use of the at least one skill in connection with the collaboration activity.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a flowchart of a method for generating a database of skills possessed by a user, according to one example of principles described herein.

FIG. 2 is a diagram of a system for generating a database of skills that are endorsed and possessed by a user, according to one example of principles described herein.

FIG. 3 is a diagram of a system for generating a database of skills possessed by a user that are used during collaboration activities, according to one example of principles described herein.

FIG. 4 is a diagram of a record in a database, according to one example of principles described herein.

FIG. 5 is a diagram of a system for generating a database of skills possessed by a user, according to one example of principles described herein.

FIG. 6 is a flowchart of a method for generating a database of skills possessed by a user, according to one example of principles described herein.

FIG. 7 is a diagram of an example a skill database generator system, according to one example of principles described herein.

Throughout the drawings, identical reference numbers designate similar, but not necessarily identical, elements.

### DETAILED DESCRIPTION

The present specification describes methods and systems for generating a database of skills possessed by a user such that the database contains a record of skills the user has demonstrated during a collaboration activity. For example, if a requested user demonstrated skill X during a collaboration activity, an initiating user may endorse the requested user with skill X during or after the collaboration activity. Once endorsed, the database may include a record of the requested user being endorsed with skill X by the initiating user with regard to the collaboration activity.

The present invention may be a system, a method, and/or a computer program product. The computer program product may include a computer readable storage medium (or media), having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus, to produce a machine such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or blocks or block diagram.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, users may have a specific set of skills. Data relating to the specific skill set for each user may be stored in a database as a record. Typically, the skills are generated via surveys about a user's skills. The survey may be completed by the user, a manager of the user, or other users of an organization. Once the survey is complete, the information from the survey is stored in the database as a record to document the skill set of each user.

Alternatively, information associated with the skills may be generated via a social network. The social network may allow users of the social network to create endorsements for other users. The endorsement may indicate that a user has obtained a specific skill. Once the endorsement is made, a record of the endorsement is stored in the database for that user.

Often, a user may be endorsed by another user for a skill the user does not actually possess or possesses only marginally. For example, the user may be endorsed by another user for a skill in an area outside the user's actual core competency where the user does not actually spend much, if any, time developing or using that skill. Such misguided endorsements of skills for the user may come from another user that does not actually have personal knowledge of the user's skill set, but feels that the endorsement of the skill will compliment or otherwise benefit the user. In some instances, the other user may not understand the skill area being endorsed for the user. In other instances, the user may not have experience with the skill area and the user being endorsed. As a result, the skills associated with the user may be inaccurately recorded in a database.

The present specification describes examples of systems and methods for generating a database of skills possessed by a user. Such a method may include, with an electronic interaction tool, detecting an interaction between a requested user and an initiating user with regard to a collaboration activity. The method includes in response to a determination that the requested user uses at least one skill from a list of skills associated with the collaboration activity, generating a prompt for the initiating user that identifies the at least one skill of the requested user. The method includes recording, in a database, a record associated with the requested user based on the collaboration activity. The record documents the collaboration activity and the requested user's use of the at least one skill in connection with the collaboration activity. Such a method allows for the a database to include of skills possessed by the requested user that are validated and a time associated with the use of the skill with regard to the collaboration activity. As a result, the database contains an accurate record of the skills possessed by users.

In the present specification and appended claims, the term “initiating user” means a user that initiates a collaboration activity. The initiating user may be an individual or a group of individuals. The initiating user may select other users to participate in the collaboration activity. Once these other users are selected, they become requested users.

In the present specification and appended claims, the term “requested user” means a user that is requested to participate in a collaboration activity by an initiating user. The requested user may be an individual or a group of individuals. The requested user may be selected by the initiating user based on the skills associated with the requested user.

In the present specification and appended claims, the term “skill” means an ability associated with a user to carry out a specific task. A skill may represent an ability and/or an expertise associated with an initiating user and/or a requested user to perform a specific task with proficiency. Skills may be derived from any of professional, avocational, recreational activities, or similar activities.

In the present specification and appended claims, the term “prompt” means a mechanism used to display skills associated with a requested user to an initiating user that may be selected by the initiating user. A prompt may be displayed to an initiating user via a display of a user device. The prompt may be generated based on an event or a specific time.

In the present specification and appended claims, the term “collaboration activity” means an interaction between at least an initiating user and a requested user that is related to a task specified by the initiating user. Some collaboration activities may occur between the initiating user and the requested user entirely online, partially online, or entirely offline. An offline collaboration activity might subsequently be documented in online or electronic records. A collaboration activity may include the requested user providing information, skills, or resources to the initiating user.

As used in the present specification and in the appended claims, the term “taxonomy” means a classification of skills associated with a user. A taxonomy may classify a set of skills for a requested user into groups. Skills with common themes may be classified into a group such that the skills in that group are related. As a result, the taxonomy allows for skills that are frequently used together to be classified together in the same group.

As used in the present specification and in the appended claims, the term “user profile” means a collection of data used to represent attributes of a requested user. A user profile may describe or list a number of skills possessed by the requested user. A user profile may be stored as part of a database, such as a human resources (HR) database, a skills database, or a database of user profiles for users of a social network. Each database may focus on different attributes of the requested users. For example, a skills database may focus on skills possessed by requested user. A social network database may include personal information about the requested user.

As used in the present specification and in the appended claims, the term “database” means a central location in which information relating to skills of a user is stored and managed. The information may be stored and managed as a record. The record may be associated with a requested user or an initiating user. The information relating to the skills associated with the requested user may be stored in one database or several databases.

As used in the present specification and in the appended claims, the term “a number of” or similar language includes any positive number, including one to infinity; zero not being a number, but the absence of a number.

In the following description, for purposes of explanation, numerous specific details are set forth in order to provide a thorough understanding of the present systems and methods. It will be apparent, however, to one skilled in the art, that the present apparatus, systems, and methods may be practiced without these specific details. Reference in the specification to “an example” or similar language means that a particular feature, structure, or characteristic described in connection with that example is included as described, but may not be included in other examples.

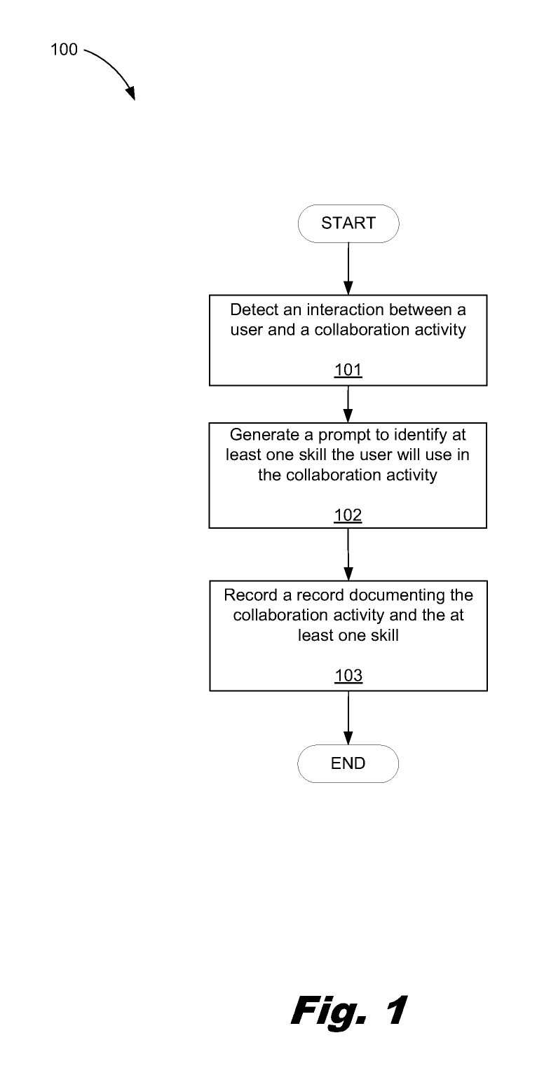

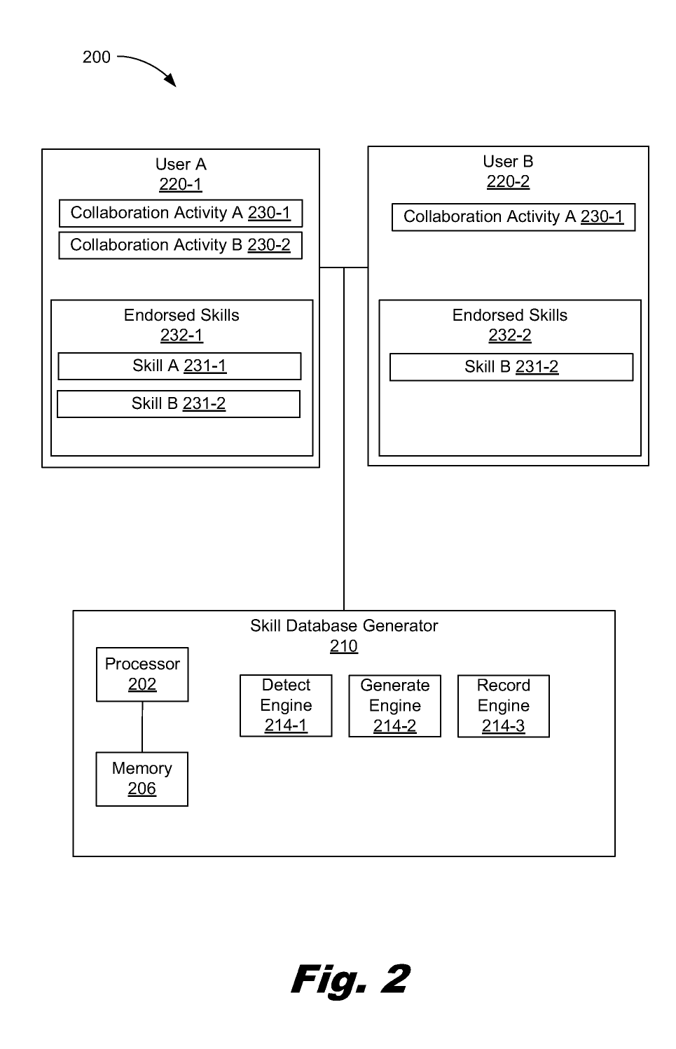

Referring now to the figures, FIG. 1 is a flowchart of an example of a method for generating a database of skills possessed by a user according to one example of principles described herein. The method (100) may be executed by a skills database generator (210) of FIG. 2. The method (100) may be executed by other systems (i.e. system 310 and system 700). In this example, the method (100) includes with an electronic interaction tool, detecting (101) an interaction between a requested user and an initiating user with regard to a collaboration activity. The method (100) includes in response to a determination that the requested user uses at least one skill from a list of skills associated with the collaboration activity generating (102) a prompt for the initiating user that identifies the at least one skill of the requested user. The method (100) includes recording (103), in a database, a record associated with the requested user based on the collaboration activity.

As mentioned above, the method (100) includes with an electronic interaction tool, detecting (101) an interaction between a requested user and an initiating user with regard to a collaboration activity. As will be described below, a user, such as an initiating user, may initiate a collaboration activity with another user, such as a requested user. The initiating user and the requested user may interact with each other during the collaboration activity.

Some collaboration activities may occur between the initiating user and the requested user entirely online. This type of collaboration activity may be in the form of an electronic mail (email), an instant message (IM), a short message service (SMS), or combinations thereof. If an initiating user sends an email to a requested user, the method (100) may detect that the initiating user and the requested user are interacting.

Other collaboration activities may occur between the initiating user and the requested user partially online. This type of collaboration activity may include combinations of emails, IM, SMS, and meetings that are conducted in person. If an initiating user sends an email to a requested user and also schedules a meeting with the requested user, the method (100) may detect that the initiating user and the requested user are interacting.

Further, some collaboration activities may occur between the initiating user and the requested user entirely offline. This type of collaboration activity may include the users meeting each other in a physical location. If the method (100) determines the collaboration activity is entirely offline, the method (100) may subsequently document the collaboration activity online or via electronic records. This may include having an initiating user upload a summary about the meeting online. As a result, the method (100) may detect different types of collaboration activities.

In one example, the initiating user may initiate a collaboration activity with another user such as a requested user. As will be described below, during the collaboration activity, a requested user participating in a collaboration activity may demonstrate skills and expertise associated with that collaboration activity. In this example, the requested user may be a professional such as an engineer. During the interaction the engineer exchanges information related to a programming language with the initiating user. This demonstrates that the engineer has skills related to the programming language. As a result, there is an interaction between the initiating user and the requested user.

In another example, the requested user may be an amateur such as a college athlete. During the collaboration activity the college athlete competes in a sporting event and demonstrates skills relating to a specific sporting event. An initiating user who initiates the collaboration activity has an opportunity to view the demonstration of the skill of the college athlete. As a result, there is an interaction between the initiating user and the requested user.

The method (100) includes in response to a determination that the requested user uses at least on skill from a list of skills associated with the collaboration activity, generating (102) a prompt for an initiating user that identifies the at least one skill for the requested user. A prompt may be a mechanism used to display skills associated with a requested user to an initiating user that may be selected by the initiating user. A prompt may be displayed to an initiating user via a display of a user device.

As will be described below, the method (100) may generate a prompt. Some of the prompt may be generated every time the method (100) is activated. Other prompts may be generated based to an event. The event may include activing the method (100) at the discretion of an initiating user, at a specific time, when a requested user acquires a specific skill, when a requested user acquires a specific job role, when a requested user becomes a part of an organization, other events, or combinations thereof. The prompts may be generated based on a time. The time may be a specific minute, hour, day, week, or year. The prompts may be generated as appropriate as indicated by the specific examples below or by other appropriate factors.

In an example, if the requested user is the engineer, a prompt may identify for the initiating user that the engineer has a programing language skill. If the requested user is the college athlete, a prompt may identify for initiating user that the college athlete has athletic skill X.

The determination may include identifying a skill the requested user is expected to use as part of the collaboration activity. For example, the determination may include identifying that the requested user is expected to use skill X and skill Y as part of the collaboration activity.

The determination may include identifying a number of skills that have been used in other collaboration activities that share common traits with the collaboration activity. For example, if collaboration activity Y used skill X and skill Y and collaboration activity Z is related to collaboration activity Y, skill X, skill Y, and other skills may be identified for collaboration activity Z.

The list of skills may be determined based on information related to the collaboration activity. For example, if the collaboration activity includes information associated with a programming language, the list of skills may be associated with programing language skills.

The prompt may be presented to the initiating user involved in the collaboration activity. For example, a list of skills determined from an email correspondence between the initiating user and the requested user is presented to the initiating user. The initiating user may then endorse the requested user for a number of skills on the list of skills.

The prompt may include a set of default answers. The default answers may indicate a number of skills in the list that are selected and waiting for confirmation of the endorsement of the skill.

The prompt may be presented for a period of time before the default answers are accepted as and recorded. For example, the prompt may display, for one day, a list of skills for which the initiating user may endorse the requested user with.

In some examples, a number of skills in the list are identified as the default skills to endorse. The default skills allow an initiating user to easily endorse the default skills for the requested user. The list of skills may be presented for a specific amount of time, such as thirty seconds before the list is no longer presented.

The method (100) includes recording (103), in a database, a record associated with the requested user based on the collaboration activity. The record documents the collaboration activity and the requested user's use of the at least one skill in connection with the collaboration activity. In one example, the record includes the requested user, an endorsement of the skill, a collaboration activity, and the initiating user who endorsed the requested user with the skill. Additional information related to the collaboration activity, such as the role the requested user had in the collaboration activity, is recorded. Future references to the record may determine the nature of the use of the skill in the collaboration activity. The nature of the use of the skill provides additional information that enhances the understanding and confidence in the endorsement of the skill.

The method (100) allows for the identification, recording, and storage of information associated with skills used during a collaboration activity. The method (100) may record endorsements of the skills for the requested user based on the participation of the requested user in the collaboration activity.

FIG. 2 is a diagram of a system for generating a database of skills that are endorsed and possessed by a user, according to one example of principles described herein. As will be described below, a skills database generator detects interactions between a requested user and an initiating user with regard to a collaboration activity. The skills database generator monitors the requested user's participation in the in the collaboration activity to determine a set of skills associated with the requested users. The skills database generator records a record of the skills associated with the requested user. The record is stored in a database to allow an initiating user to access and gain knowledge about the requested user.

As illustrated, the diagram (200) includes a number of users (220). The diagram (200) includes user A (220-1) and user B (220-2). User A (220-1) or user B (220-2) may be a requested user or an initiating user depending on if they initiated an interaction with regard to a collaboration activity. For example, if user A (220-1) requests that user B (220-2) be involved in a collaboration activity, user A (220-1) may be the initiating user and user B (220-2) may be the requested user. Alternatively, if user B (220-2) requests that user A (220-1) be involved in a collaboration activity, user B (220-2) may be the initiating user and user A (220-1) may be the requested user.

Each of the users (220) may be associated with a collaboration activity (230). For example, user A (220-1) may be associated with collaboration activity A (230-1) and collaboration activity B (230-2). User B (220-2) may be associated with collaboration activity A (230-1). In an example, user A (220-1) initiates collaboration activity A (230-1) with user B (220-2) and collaboration activity B (230-2). As a result, user A (220-1) is an initiating user for collaboration activity A (230-1) and collaboration activity B (230-2). Further, since user A (220-1) initiated collaboration activity A (230-1) with user B (220-2), user B (220-2) is the requested user for collaboration activity A (230-1). Collaboration Activity A (230-1) may be an online interaction via an email. Collaboration Activity B (230-2) may be an online interaction via an 1M chat.

As illustrated, each user (220) may have a number of skills (232) that have been endorsed by other users in the past. For example, A user (220) may be endorsed with skill A (231-1) and skill B (231-2). Skill A (231-1) may be a programming skill. Skill B (231-2) may be a negotiating skill. User B (220-2) may be endorsed with skill B (231-2). Each of the skills (231) that the users (220) are endorsed with indicates that that user is proficient with that skill. For example, since user A (220-1) is endorsed with skill A (231-1), user A (220-1) is proficient with a programming skill.

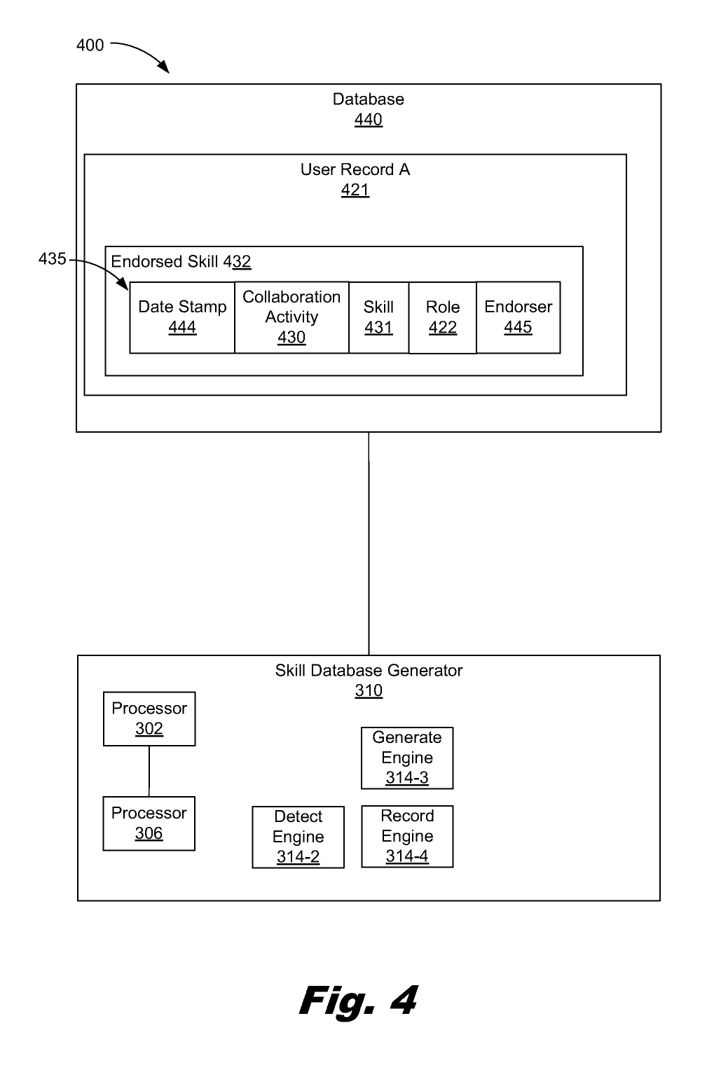

Information associated with each of the skills (231) for each of the users (220) may be stored as a record in a database (440). For example, a record associated with user A (220-1) may include information associated with collaboration activity A (230-1), collaboration activity B (230-2), skill A (231-1), and skill B (231-2). More information about the database (440) will be described in FIG. 4.

As illustrated, the diagram (200) includes a skills database generator (210). The skills database generator (210) records the endorsements of skills that a requested user (220) receives while working on a collaboration activity (230) with an initiating user. As illustrated, the skills database generator (210) includes a processor (202), memory (206), and a number of engines (214). The processor (202) executes computer program code to perform a task. The processor (202) executes computer program code associated with each of the number of engines (214). The engines (214) may cause the processor (202) to store data in memory (206). The memory (206) may include volatile memory used to execute the computer program code associated with each engine (214). The skills database generator (210) includes a detect engine (214-1), a generate engine (214-2), and a record engine (214-4).

The detect engine (214-1) includes computer program code to, when executed by the processor (202), detect an interaction between a requested user and an initiating user with regard to a collaboration activity. The detect engine (214-1) may receive a notice, as part of the interaction, that a collaboration activity is beginning The detect engine (214-1) may monitor the collaboration activities (230) to detect activity associated with the collaboration activity. The detect engine (214-1) may monitor a user's activity to detect participation in a collaboration activity (230). The detect engine (214-1) may monitor an existing collaboration activity (230) for additional activity or changes in activity associated with the collaboration activity. Further, the detect engine (214-1) may use similar approaches to detect an interaction activity. In an example, the detect engine (214-1) detects an interaction between user A (220-1), an initiating user, and user B (220-2), a requested user, with regard to collaboration activity A (230-1).

The generate engine (214-2) includes computer program code to, when executed by the processor (202) in response to a determination that the requested user will use at least one skill from a list of skills associated with the collaboration activity, generate for the initiating user a prompt to identify the at least one skill of the requested user. The prompt may be generated before the requested user participates in a collaboration activity. For example, the prompt may be generated for user A (220-1) before user B (220-2) participates in collaboration activity A (230-1).

The prompt may be generated while the requested user participates in a collaboration activity. For example, the prompt may be generated for user A (220-1) while user B (220-2) participates in collaboration activity A (230-1). The prompt may be generated at the end of the requested user's participation in the collaboration activity. For example, the prompt may be generated for user A (220-1) at the end of collaboration activity A (230-1).

In one example, the prompt is a list of skills from which the initial user may select relevant skills associated with the requested user for the collaboration activity. For example, a list of skill for user B (220-2), such as skill B (231-2), may be provided to user A (220-1) for collaboration activity A (230-1). Once the list of skills is provided, user A (220-1) may select skill B (231-2) for user B (220-2) user for collaboration activity A (230-1). The prompt may include a list of skills provided to computing device to identify skills relevant to a requested user or collaboration activity (230).

The prompt may be displayed to the initiating user, allowing the initiating user to endorse the requested user with a skill. For example, the prompt may be displayed to user A (220-1). The prompt may include check boxes or radio buttons next to the skill of user B (220-2). User A (220-1) may select, via the check boxes or radio buttons, skill B (231-2) to endorse user B (231-2) will skill B (231-2). In another example, the prompt indicates a default set of skills to be endorsed for the requested user. The default set of skills may include all skills associated with the requested user. For example, skill B (231-2) may be the default set of skills for user B (220-2).

The prompt may allow the identification of a skill for the requested user that may not be a part of a list of skills. For example, if user B (220-2) demonstrated an expertise related to skill Y, the prompt may include skill Y.

The record engine (214-3) includes computer program code to, when executed by the processor (202), record, in the database (440), a record associated with the requested user based on the collaboration activity. The record documents the collaboration activity and the requested user's use of the at least one skill in connection with the collaboration activity. For example, the record engine (214-3) records, in the database (440), a record associated with user B (220-2) based on user B′s participation in collaboration activity A (230-1) with regard to skill B (231-2).

The record may include an indication of when the skill was used by the requested user and the purpose for which the skill was used. For example, the record may indicate that skill B (231-2) was lasted used by user B (220-2) yesterday. The record may document the frequency with which a skill is used by the requested user. For example, the record may indicate that skill B (231-2) was is used by user B (220-2) every day. The record may document the nature of the use of the skill, such as the network for which the skill is used. For example, the record may indicate that skill B (231-2) was used by user B (220-2) for social network Y. The record may document interaction with a number of additional users involved in a collaboration activity. For example, the record may indicate that user A (220-1), user B (220-2) and user C were involved in collaboration activity A (230-1). More information about the record will be described in FIG. 4.

An overall example of FIG. 2 will now be given. The detect engine (214-1) detects that user A (220-1) and user B (220-2) begin working on collaboration activity A (230-1). User A (220-1) is the initiating user and user B (220-2) is the requested user. The detect engine (214-1) detects that collaboration activity A (230-1) uses skill B (231-2).

The generate engine (214-2) generates a prompt for user A (220-1) to allow user A (220-1) to endorse user B (220-1) for skill B (231-2). The prompt is generated while the users (220) are engaged in collaboration activity A (230-1). The prompt includes a list of skills including skill B (231-2). The selection of skill B (231-2) by user A (220-1) for user B (220-2) is received by the skill database generator (210). The selection of skill B (231-2) indicates that user A (220-1) has endorsed user B (220-2) with skill B (231-2).

The record engine (214-3) records the selection of skill B (231-2) in a record associated with user B (220-2) in the database (440). The record includes information about the relationship between user A (220-1), user B (220-2), collaboration activity A (230-1), and skill B (231-2). The information about the relationship informs future queries about the skills associated with user B (220-2).

While this example has been described with reference to the database being located on the skills database generator, the database may be located in other locations. For example, the database may be located over a network, on a user device, on a server, other locations, or combinations thereof.

While this example has been described with reference to an initiating user endorsing a requested user with a skill, the requested user may endorse the initiating user with a skill. As a result, a prompt may be generated for the requested user such that the requested user may endorse the initiating user with a skill.

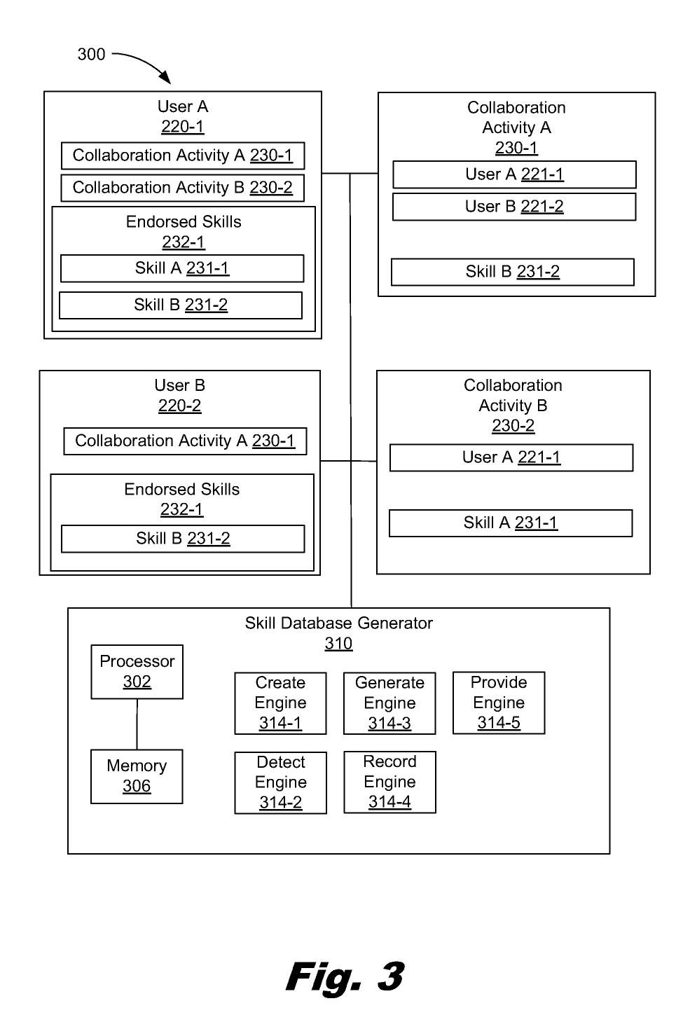

FIG. 3 is a diagram of a system for generating a database of skills possessed by a user that are used during collaboration activities, according to one example of principles described herein. As described above, a skills database generator detects interactions between users and collaboration activities.

As described above, a number of users (220) participate in a number of collaboration activities (230). As illustrated, user A (220-1) participates in collaboration activity A (231-1) and collaboration activity B (231-2). User A (220-1) has skills that have been endorsed by other users. As illustrated, user A (220-1) has been endorsed with skill A (231-1) and skill B (231-2).

As illustrated, user B (220-2) participates in collaboration activity A (230-1). User B has been endorsed with skill B (231-2) by other users.

A number of collaboration activities (230) are associated with a number of user records (221) and a number of skills (231). As illustrated, collaboration activity A (230-1) is associated with user record A (221-1) and user record B (221-2). In an example, user record A (221-1) may be a record associated with user A (220-1). User record B (221-2) may be a record associated with user B (220-2). Collaboration activity A (230-1) is also associated with skill B (231-2). Similarly, collaboration activity B (230-2) is associated with user A (221-1) and skill A (231-1).

As illustrated, the diagram includes a skills database generator (310). As mentioned above, the skills database generator (310) includes a processor (302), memory (306) communicatively connected to the processor (302), and a number of engines (314). Each engine (314) causes the processor (302) to perform a particular task. The engines (314) cause the skills database generator (310) to generate a database of skills associated with the users (220). The skills database generator (310) records the information associated with the skills and endorsements that users (220) receive while working on a collaboration activity (230). For example, the skills database generator (310) allows a requested user to be endorsed by an initiating user associated with a collaboration activity (230). In other examples, the, the skills database generator (310) allows an initiating user to be endorsed by a requested user associated with a collaboration activity (230). The skills database generator (310) provides that the skill (231) is identified based on actual knowledge and experience of someone who has worked with the user.

As illustrated, the skill database generator (310) includes a create engine (314-1). The create engine (314-1) includes computer program code to, when executed by the processor (302), create a skill taxonomy. The skill taxonomy describes a classification of skills that are used in connection with a number of collaboration activities. For example, the skill taxonomy includes terms such as architect, innovation, master inventor, other terms or combinations thereof. The create engine (314-1) may use a folksonomy as a basis for the skill taxonomy. The folksonomy may be a scheme of classification and organization of online content into different categories by the use of metadata, such as electronic tags. A folksonomy of skills allows for user to define a classification of skills. Skills that a user groups together may have common usage. A folksonomy of skills allows for skills that are identified to be used together to be classified together. In one example, the skill taxonomy describes a number of skills that are commonly used together.

In another example, the skill taxonomy describes a number of skills that are commonly possessed by the same user. The skill taxonomy may be created by analyzing prior interactions between users for specific collaboration activities. Similarly, the skill taxonomy may be created by analyzing the skills a number of users possess. The skills taxonomy may be used by the skills database generator (310) to correlate a user (220) with a number of skills (231). In still another example, a user analyzes interactions between users to create a skill folksonomy. The user inputs the skills folksonomy, which is used to by the create engine (314-1) as a basis for the skill taxonomy.

The detect engine (314-2) includes computer program code to, when executed by the processor (302), detect an interaction between a requested user and an initiating user with regard to a collaboration activity. As described above, the generate engine (314-3) includes computer program code to, when executed by the processor (302), generate a prompt for the initiating user, in response to a determination that the requested user will use at least one skill from a list of skills associated with the collaboration activity, to identify the at least one skill for the requested user. As described above, the record engine (314-4) includes computer program code to, when executed by the processor (302), record in a database a record associated with the skills of the requested user based on the collaboration activity.

The provide engine (314-5) includes computer program code to, when executed by the processor (302), selectively provide, based on a number of records associated with the requested user, a user profile describing a number of skills the requested user has used, an indication of when each of the number of skills was used, and with whom the number of skills were used.

In one example, each of the skills in the user profile may be associated with a relevance weight. The relevance weight may indicate how relevant the skill is to the user and/or a collaboration activity. In some examples, the relevance weight may be symbolic such as high, medium, or low. A relevance weight that is low indicates the skill is not relevant to the collaboration activity or the user hasn't used that skill recently. A relevance weight that is high indicates the skill is relevant to the collaboration activity or the user has used that skill recently. The provide engine (314-5) may modify the relevance weight for each skill by lowering a relevance weight for a specific skill over a specified period. For example, if a relevance weight for skill X is high, each week a user does not use skill X, the provide engine (314-5) may modify the relevance weight. This may include lowering the relevance weight for skill X from high to medium if the user does not use skill X for a week. If the user still hasn't used skill X the following week, the relevance weight for skill X may be modified from medium to low. In another example, the provide engine (314-5) increases the relevance weight for a specific skill over a specified period. For example, if a relevance weight for skill X is low, each week a user uses skill X, the provide engine (314-5) may modify the relevance weight.

Depending on the relevance weight for a skill, the skill may or may not be included in the user profile. If user A′s skill A (231-1) has a high relevance weight and skill B (231-2) has a low relevance weight, skill A (231-1) may be included in the user profile. However, because skill B (231-2) has a low relevance weight, skill B (231-2) may not be included in the profile.

The provide engine (314-5) may provide the number of skills the user has used based on when the skill was last used. The provide engine (314-5) may allow each of the users (220) and to access information associated with each other in the database (440).

An overall example according to FIG. 3 will now be given. The create engine (314-1) creates a skill taxonomy. The skill taxonomy indicates that skill A (231-1) is associated with collaboration activity B (230-2). The skill taxonomy indicates a number of additional skills often associated with skill A (231-1). The skill taxonomy further indicates that skill B (231-2) is associated with collaboration activity B (231-2). The skill taxonomy still further identifies that skill A (231-1) and skill B (220-1) are sometimes possessed by the same user.

The detect engine (314-2) detects user A (220-1) and user B (220-2) interacting via collaboration activity A (230-1). Collaboration activity A (230-1) uses skill B (231-2). The detect engine (314-2) detects the use of skill B (231-2) in connection with collaboration activity A (230-1). The detect engine (314-2) also detects that user A (220-1) is involved in collaboration activity B (230-2).

The generate engine (314-3) generates a prompt. In this example, a prompt is provided to user B (220-2), allowing user B (220-2) to select a number of skills to endorse user A (220-1) with. The list includes skill B (231-2), because skill B (231-2) is associated with collaboration activity A (230-1). Since collaboration activity A (230-1) is associated with both user record A (221-1) and user record B (221-2), user B (220-2) may endorse user A (220-1) for skill B (231-2). User B (220-2) may not endorse user A (220-1) for skill A (231-1) because user A (220-1) and user B (220-2) have not been involved in a common collaboration activity that includes skill A (231-1). Further, there is no evidence that user B (220-2) has any knowledge or expertise with skill A (231-1). The generate engine (314-3) receives the selection of an endorsement from user B (220-2) that user B endorses user A (220-1) for skill B (231-2).

The record engine (314-4) records the selection made by user B (220-2) in the database (440). The record engine (314-4) may record the selection to endorse user A (220-1) as part of data associated with user A (220-1). The record engine (314-4) may record the selection as part of a record describing collaboration activity A (230-1). The record engine (314-4) includes additional information about when the skill B (231-2) was used, the role of user A (220-1) in collaboration activity A (230-1), and the role of user B (220-2) in collaboration activity A (230-1).

FIG. 4 is a diagram of a record in a database, according to one example of principles described herein. As mentioned above, the skills database generator stores, in a database, information related to skills for a user.

As illustrated in FIG. 4, the skill database generator (310) generates user records in a database (440). The database (440) includes user record A (421-1) for user A. Although one user record is present in the database, a number of other user records may be present in the database (440). User record A (321-1) includes information about skills that have been endorsed by other users for user A.

As illustrated, the database (440) includes user record A (321-1). User record A (421) may be associated with user A (220-1). User record A (421) includes a skills record (432). The skill record (432) describes an endorsement received by user A for a specific skill. As a result, the skill record (432) includes information to provide context to the skill that another user has endorsed user A with. In some examples the skill record (435) may add value by providing information relating to the use of the skill and the relationship to the user who endorsed user A with the skill.

As illustrated, the skill record (435) includes a date stamp (444). The date stamp (444) indicates when user A (220-1) was endorsed by another user. The date stamp (444) may include a time, a day, a month, and a year.

The skill record (435) includes a collaboration activity (430). The collaboration activity (430) may indicate which collaboration activity user A (220-1) was participating in when user A (220-1) received the endorsement for the skill. For example, the collaboration activity (430) in the skill record (432) may indicate user A (220-1) was participating in collaboration activity A (430-1) when user A (220-1) received the endorsement for the skill.

The skill record (435) includes a skill (431). The skill (431) may represent an ability and/or an expertise associated with user A (220-1). The skill (431) may be derived from any of professional, avocational, recreational activities, or similar activities. In an example, the skill (431) may be programming language B.

The skill record (435) includes a role (422). The role (422) may indicate what user A did during the collaboration activity (430). The role (422) may include, for example, programming electronic circuits.

The skill record (435) includes an endorser (445). The endorser (445) may be the initiating user that selects, via a prompt, the skill (431) to endorse user A with. In this example, the endorser (445) is user B (220-2).

An example according to FIG. 4 will now be given. The skills database generator (310) detects, using the detect engine (314-2), user A (FIG. 2, 220-1) and user B (FIG. 2, 220-2) interacting on collaboration activity A (430-1). The skills database generator (310) generates a prompt for user B (FIG. 2, 220-2) to allow user B to endorse skills for user A (FIG. 2, 220-1). The prompt includes a list of skills including skill B (431-2), because user skill B is used for collaboration activity A (430-1). User B (FIG. 2, 220-2) selects to endorse user A (FIG. 2, 220-1) for skill B (FIG. 2, 231-2). The skills database generator (310) records the selection by creating a skill record (432) that includes a date stamp (444) of Sep. 25, 2015, collaboration activity A for the collaboration activity (430), skill B for the skill (431), programmer as the role (422), and user B as the endorser (445). As a result, the skill record (435) provides a time and contextual information for the skill that is being endorsed.

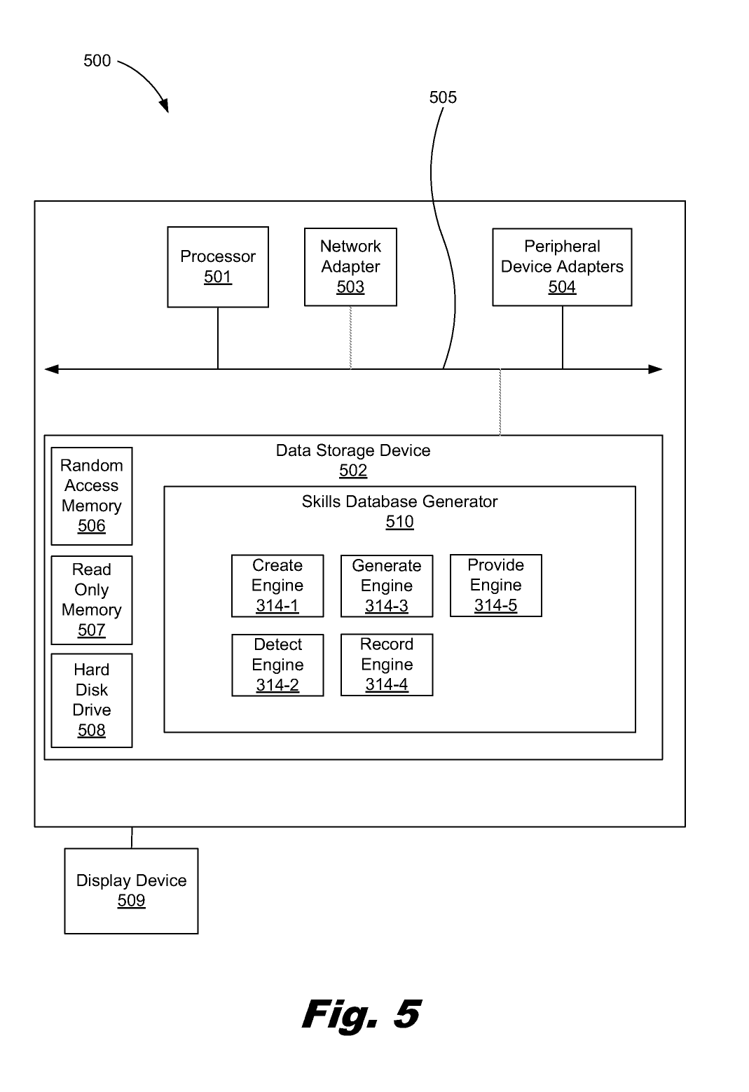

FIG. 5 is a diagram of a computing device for generating a database of skills possessed by a user, according to one example of the principles described herein. The computing device (500) for generating a database of skills possessed by a user may be implemented by an electronic device. Examples of electronic devices include servers, desktop computers, laptop computers, personal digital assistants (PDAs), mobile devices, smartphones, smart devices, gaming systems, and tablets, among other electronic devices.

The computing device (500) may be utilized in any data-processing scenario, including stand-alone hardware, mobile applications, a computing network, or combinations thereof. Further, the computing device (500) may be used in a computing network, a public cloud network, a private cloud network, a hybrid cloud network, other forms of networks, or combinations thereof. In one example, the methods provided by the computing device (500) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, networks, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing device (500) are executed by a local administrator.

To achieve its desired functionality, the computing device (500) includes various hardware components. Among these hardware components may be a number of processors (501), a number of data storage devices (502), a number of peripheral device adapters (504), and a number of network adapters (503). These hardware components may be interconnected through the use of a number of buses and/or network connections. In one example, the processor (501), data storage device (502), peripheral device adapters (504), and a network adapter (503) may be communicatively coupled via a bus (505).

The data storage device (502) stores data, such as executable program code, that is executed by the processor (501) or other processing device. As will be discussed, the data storage device (502) may specifically store computer code representing a number of applications that the processor (501) executes to implement at least the functionality described herein.

The data storage device (502) may include various types of memory modules, including volatile and nonvolatile memory. For example, the displaying system (502) of the present example includes Random Access Memory (RAM) (506), Read Only Memory (ROM) (507), and Hard Disk Drive (HDD) memory (508). Many other types of memory may also be utilized, and the present specification contemplates the use of as many varying type(s) of memory in the data storage device (502) as may suit a particular application of the principles described herein. In certain examples, different types of memory in the data storage device (502) may be used for different data storage needs. For example, in certain examples, the processor (501) may boot from Read Only Memory (ROM) (507), maintain nonvolatile storage in the Hard Disk Drive (HDD) memory (508), and execute program code stored in Random Access Memory (RAM) (506).

Generally, the data storage device (502) comprises a computer readable medium, a computer readable storage medium, or a non-transitory computer readable medium, among others. For example, the data storage device (502) may be, but is not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store computer usable program code for use by, or in connection with, an instruction execution system, apparatus, or device. In another example, a computer readable storage medium may be any non-transitory medium that can contain or store a program for use by, or in connection with, an instruction execution system, apparatus, or device.

The hardware adapters (503, 504) in the computing device (500) enable the processor (501) to interface with various other hardware elements, external and internal to the computing device (500). For example, the peripheral device adapters (504) may provide an interface to input/output devices, such as, for example, a display device (509), a mouse, or a keyboard. The peripheral device adapters (503) may also provide access to other external devices, such as an external storage device, a number of network devices such as, for example, servers, switches, and routers, client devices, other types of computing devices, and combinations thereof.

The display device (509) allows a user of the computing device (500) to interact with and implement the functionality of the computing device (500). The peripheral device adapters (504) may also create an interface between the processor (501) and the display device (509), a printer, or other media output devices. The network adapter (503) may provide an interface to other computing devices within, for example, a network, thereby enabling the transmission of data between the computing device (500) and other devices located within the network.

The computing device (500) may, when executed by the processor (501), display the number of graphical user interfaces (GUIs) on the display device (509) associated with the executable program code, representing the number of applications stored on the data storage device (502). The GUIs may include aspects of the executable code, including displaying a number of messages to a user. When the dedicated portion of the GUI changes size, a new number of messages are selected and displayed. The GUIs may display, for example, a number of skills associated with a user. Examples of display devices (509) include a computer screen, a laptop screen, a mobile device screen, a personal digital assistant (PDA) screen, and a tablet screen, among other display devices (509). Examples of the GUIs displayed on the display device (509) will be described in more detail below.

The computing device (500) includes a number of engines used in the implementation of generating a skills database for a user. The various engines within the computing device (500) include executable program code that may be executed separately. In this example, the various engines may be stored as separate computer program products. In another example, the various engines within the computing device (500) may be combined within a number of computer program products; each computer program product includes a number of the engines.

Aspects of the present system and method are described herein with reference to flowchart illustrations and/or block diagrams of methods, apparatus (systems) and computer program products, according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (501) of the computing device (500) or other programmable data processing apparatus, implements the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The computing device (500) includes a number of engines (314). The engines (314) are made to, when executed by the processor (501), cause the processor (501) to perform a specified function. The engines (314) include a create engine (314-1), a detect engine (314-2), a generate engine (314-3), a record engine (314-4), and a provide engine (314-5).

The create engine (314-1) creates a skill taxonomy. The skill taxonomy describes a classification of skills that are used in connection with a number of collaboration activities. The create engine (314-1) may use information associated with a collaboration activity to create a skill taxonomy. The create engine (314-1) may use data from additional collaboration activities to create the skill taxonomy. For example, a number of other collaboration activities may use a set of skills together, so that a set of skills is added to the skill taxonomy when any one of those skills is added to the skill taxonomy. The create engine (314-1) may examine communication associated with a collaboration activity to create the skill taxonomy. For example, the create engine (314-1) may use natural language analysis of a communication between users to determine the skills that are used in a collaboration activity. The create engine (314-1) may use skill synonyms or groupings to create a common set of skills in the skill taxonomy. For example, the create engine (314-1) may recognize that two skills, while having different titles, frequently address the same underlying skill. The skill taxonomy may be based on skills of a user initiating a collaboration activity. The create engine (314-1) may receive changes to the taxonomy from a user or a set of computer program code.

The detect engine (314-2) detects, with an electronic interaction tool, an interaction between a requested user and an initiating user with regard to a collaboration activity. The detect engine (314-2) may use an electronic interaction tool to monitor a set of collaboration activities, to determine when a requested user and the initiating user are interacting with each other. For example, the detect engine (314-2) may monitor a database for changes to interactions between the requested user and the initiating user. When a change in an interaction is detected, the detect engine (314-2) identifies the users involved in the collaboration activity.

A collaboration activity may include a meeting. The meeting may be a face to face interaction between the initiating user and the requested user. The meeting may take place in a physical location such as a conference room of a building.

A collaboration activity may include a file share. The file share may include an initiating user requesting, via email sent to a requested user, a specific file to complete a task. The email may include the title of the file or details about the file. The requesting user may send, via an email to the initiating user, the specific file. As result, the initiating user and the requested user interact, via email, during the collaboration activity.

A collaboration activity may include a request for input. The initiating user may request, via an IM sent to a requested user, how best to complete a task The requested user may respond to the initiating user via an IM specific the best way to complete the task.

A collaboration activity may include a question and answer. The initiating user may send, via an IM, a question to a requested user. The question may be is product X compatible with product Y. The requested user may respond to the initiating user via an IM stating product X is compatible with product Y. While specific examples are given above for a type of collaboration activity, other types of collaboration activity may exist.

The generate engine (314-3) generates, in response to a determination that the requested user will use at least one skill from a list of skills associated with the collaboration activity, a prompt for the initiating user to identify the at least one skill of the requested user. The prompt may present the initiating user with a list of skills, as identified in the skill taxonomy, for which the initiating user may endorse the requested user with. The prompt may be generated at the beginning of the interaction. The prompt may be generated as part of the completion of an interaction. For example, as part of the conclusion of a project the initiating user may be prompted to endorse the requested user with a specific skill demonstrated in the interaction with regard to the collaboration activity.

The record engine (314-4) records, in a database, a record associated with the requested user based on the collaboration activity. The record documents the collaboration activity and the requested user's use of the at least one skill in connection with the collaboration activity. The record may include who endorsed the requested user with the skill. The record may include a time or date stamp, the requested user's role, the skill, an amount of involvement in the activity, the identity of the endorser, or similar information to provide details about the endorsement. The record may include information about the role the requested user played when a skill was used. The role the requested user played in the collaboration activity may indicate the purpose for which the skill was used.

The provide engine (314-5) provides, based on a number of records associated with the requested user, a user profile. The user profile describes a number of skills the requested user has used, when each of the number of skills was used, and the collaboration activity with which the number of skills were used. The skills may be provided based on when the skill was used. A skill that has not been used for an extended period of time may not be provided.

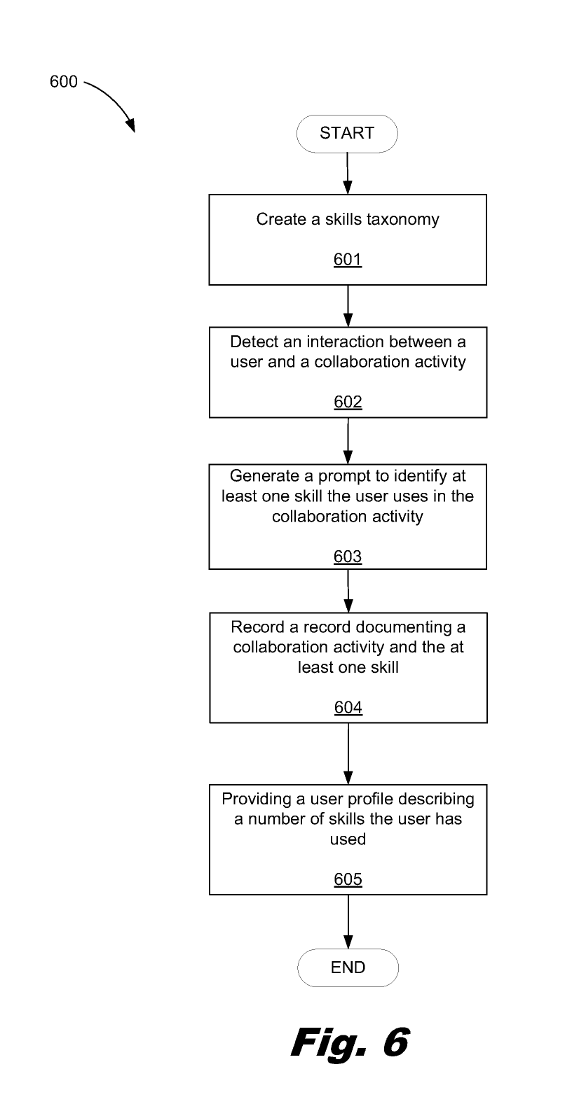

FIG. 6 is a flowchart of an example of a method for generating a database of skills possessed by a user, according to one example of principles described herein. The method (600) may be executed by the skills database generator (210) of FIG. 1. The method (600) may be executed by other systems (i.e. system 310 and system 700). In this example, the method (600) includes creating (601) a skill taxonomy. The method (600) includes with an electronic interaction tool, detecting (602) an interaction between a requested user and an initiating user with regard to a collaboration activity. The method (600) includes in response to a determination that the requested user uses at least on skill from a list of skills associated with a collaboration activity, generating (603) a prompt for the initiating user that identifies the at least one skill of the requested user. The method (600) includes recording (604) in a database a record associated with the requested user based on the collaboration activity. The method (600) includes providing (605) the user profile, which provides the number of skills the requested user has used, based on when the skill was last used by the requested user.

As mentioned above, the method (600) includes creating (601) a skill taxonomy. The skill taxonomy describes a classification of skills that are used in connection with a number of collaboration activities. The skills may be associated with the requested user. In some examples, a human resource (HR) team may create the skill taxonomy. The skill taxonomy may be used in a prompt as a list of skills used by the requested user.

As mentioned above, the method (600) includes providing (605), based on a number of records associated with the requested user, a user profile. The user profile describes a number of skills the requested user has used, an indication of when each of the number of skills was used by the requested user, and with whom the number of skills were used. The providing (605) may provide skills based on the number of endorsements, the skills of the user providing an endorsement, and skills related to the collaboration activity.

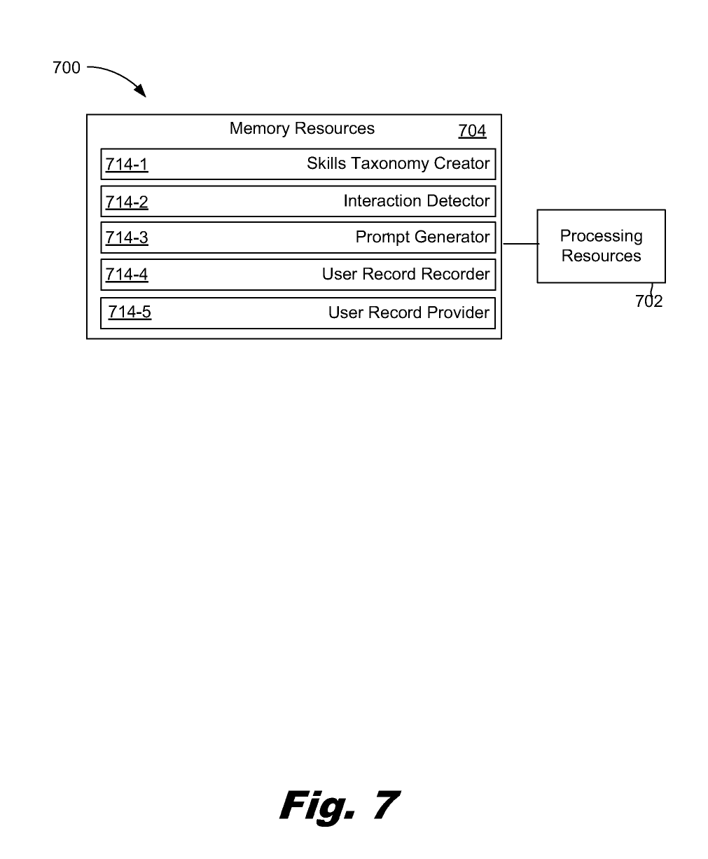

FIG. 7 is a diagram of an example of a skills database generator system (700), according to the principles described herein. In this example, the skills database generator system (700) includes processing resources (702) that are in communication with memory resources (704). Processing resources (702) include at least one processor and other resources used to process programmed instructions. The memory resources (704) generally represent any memory capable of storing data, such as programmed instructions or data structures used by the skills database generator system (700). The programmed instructions shown stored in the memory resources (704) include a skills taxonomy creator (714-1), an interaction detector (714-2), a prompt generator (714-3), a user record recorder (714-4), and a user profile provider (714-5).

The memory resources (704) include a computer readable storage medium that contains computer readable program code to cause tasks to be executed by the processing resources (702). The computer readable storage medium may be a tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, other types of memory, or combinations thereof.

The skills taxonomy creator (714-1) represents programmed instructions that, when executed, cause the processing resource (702) to create a skills taxonomy. The skills taxonomy describes a classification of skills that are used in connection with a number of collaboration activities.

The interaction detector (714-2) represents programmed instructions that, when executed, cause the processing resource (702) to detect, with an electronic interaction tool, an interaction between a requested user and an initiating user with regard to a collaboration activity. The interaction detector (714-2) may receive a notification of an interaction between a user and a collaboration activity.

The prompt generator (714-3) represents programmed instructions that, when executed, cause the processing resource (702) to generate in response to a determination that a requested user uses at least one skill associated with the collaboration activity, a prompt for the initiating user to identify at least one skill of the requested user. The list of skills may be identified in the skill taxonomy.

The user record recorder (714-4) represents programmed instructions that, when executed, cause the processing resource (702) to record, in a database, a record associated with the requested user based on the collaboration activity. The record documents the collaboration activity and the requested user's use of the at least one skill in connection with the collaboration activity.

The user profile provider (714-5) represents programmed instructions that, when executed, cause the processing resource (702) to provide, based on a number of records associated with the requested user, a user profile. The user profile describes a number of skills the requested user has used, when each of the number of skills the requested user has used, and the collaboration activity the number of skills were used with.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

1-8. (canceled)

9. A system for generating a database of skills possessed by a user, the system comprising:
a processor;
memory, communicatively connected to the processor;
a skill database generator, the skill database generator comprising:
a create engine to create a skill taxonomy, the skill taxonomy describing classification of skills that are used in connection with a collaboration activity;
a detect engine to detect, with an electronic interaction tool, an interaction between a requested user and an initiating user with regard to the collaboration activity;
a generate engine to generate, in response to a determination that the requested use will use at least one skill from a list of skills associated with the collaboration activity, generate a prompt for the initiating user to identify at least one skill of the requested user;
a record engine to record, in a database, a record associated with the requested user based on the collaboration activity, the record documenting the collaboration activity and the requested user's use of the at least one skill in connection with the collaboration activity; and
a provide engine to selectively provide, based on a number of records associated with the requested user, a user profile, the user profile describing a number of skills the requested user has used, when each of the number of skills was used, and with which collaboration activity the number of skills were used.

10. The system of claim 9, wherein the generate engine generates a prompt when the initiating user begins the interaction with the requested user with regard to the collaboration activity.

11. The system of claim 9, wherein the generate engine generates a prompt when the initiating user completes the interaction with the requested user with regard to the collaboration activity.

12. The system of claim 9, wherein the provide engine modifies a relevance weight of the at least one skill based on when that skill was last used by the requested user.

13. The system of claim 9, wherein the skill taxonomy is associated with the collaboration activity

14. The system of claim 13, wherein the skill taxonomy associated with the collaboration activity is created from skills associated with the initiating user, the initiating user inviting the requested user to participate in the collaboration activity

15. A machine-readable non-volatile storage medium encoded with instructions for generating a database of skills possessed by a user, the instructions executable by a processor of a system to cause the system to:
create a skills taxonomy, the skills taxonomy describing a classification of skills that are used in connection with a collaboration activities;
detect, with an electronic interaction tool, an interaction between an requested user and an initiating user with regard to the collaboration activity;
generate, in response to a determination that the requested user uses at least one skill associated with the collaboration activity, a prompt for the initiating user to identify at least one skill of the requested user; and
record, in a database, a record associated with the requested user based on the collaboration activity, the record documenting the collaboration activity and the requested user's use of the at least one skill in connection with the collaboration activity.

16. The machine-readable storage medium of claim 15, further comprising instructions that, when executed, cause the processor to provide, based on a number of records associated with the requested user, a user profile, the user profile describing a number of skills the requested user has used, when each of the number of skills was used, and with which collaboration activity the number of skills were used.

17. The machine-readable storage medium of claim 15, wherein the record documenting the collaboration activity and the requested user's use of the at least one skill in connection with the collaboration activity comprises an indication of when the skill was used and the purpose for which the skill was used.

18. The machine-readable storage medium of claim 15, wherein the record documenting the collaboration activity and the requested user's use of the at least one skill in connection with the collaboration activity comprises documenting the interaction with a number of additional users involved in the collaboration activity.

19. The machine-readable storage medium of claim 15, wherein a collaboration activity is a meeting, a file share, a request for input, a question and answer, or a data repository update.

20. The machine-readable storage medium of claim 15, wherein the prompt to identify at least one skill of the requested user provides the list of skills associated with the requested user that can be viewed by an initiating user.
